(19) United States
(12) Patent Application Publication
(10) Pub. No.: US 2008/0013709 A1
(43) Pub. Date: Jan. 17, 2008

(54) Interactive learning method for a handheld communication device

(75) Inventors: Cheng-Shing Lai, Taipei (TW); Wan-Jun Liu, Nanking City (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/785,686

(22) Filed: Apr. 19, 2007

(30) Foreign Application Priority Data
Apr. 25, 2006 (TW) 95114708

(51) Int. Cl. H04M 3/42; G09B 7/00

(52) U.S. Cl. 379/207.03; 434/350

(57) ABSTRACT

An interactive learning method for a handheld communication device is provided. The handheld communication device is communicated with a communication terminal. The learning method includes the following steps: calculating a preset time interval upon receipt of a predetermined command; generating an alarm signal after passing through the preset time interval; connecting to the communication terminal; and attending a lecture offered by the communication terminal.

### FIELD OF THE INVENTION

The present invention relates to a learning method, and more particularly to an interactive learning method for a handheld communication device.

### BACKGROUND OF THE INVENTION

In the past, in order to learn knowledge and skills, most people generally listen to the lecture at academic institute or schools, recite repeatedly and orally after the teacher or read books. Due to rapid development in the electronic and computer technology and prevalence of the Internet, the learning method in search of knowledge has changed, such as active learning via the multimedia. When the learning method is thus arranged, the learning inspiration is aroused, thereby enhancing the learning environment of a learner.

In the earlier time, the multimedia generally provides a passive type of learning. That is the learner can study a given lesson in a single way and not the interactive manner. For instance, a student can conduct self-study or learn English with the assistance of an optical disk. During the self-study, the student does his lesson according to the instruction of the optical disk. In case the student encounters some difficulty or doubts, he or she cannot raise or ask the question personally to the teacher as he would when attending the lecture in the class. It is inconvenient for the student to learn English in the aforesaid manner.

In order to remedy the aforementioned disadvantages encountered during the study, a network interactive learning method has been proposed. Therefore, a student can conduct his lesson or study as if he or she is personally attending the lecture in the classroom and that in case he encounters some problems or doubts concerning the lecture, he can directly ask the question by means of the network to the lecture provider.

The advance of the technology enables the notebook computer, PDA (personal digital assistant) and WAP (wireless application protocol, WAP) mobile phone to have compact dimension in addition to being in communication with the Internet. Furthermore, the development of wireless communication technology permits the user of one of these mobile communication devices to be connected to the Internet without the restriction of cable connections. Under this, the learning of one art becomes more and more convenient.

It is noted that though the interactive learning method becomes more and more popular and prevalent, the student may forget the time or occasion for attending the lecture due to business or unavoidable circumstance. Therefore, in order to prevent the occurrence of forgetfulness and to remind the student the time is due for conducting the study over the network, an interactive learning method has been proposed according to the present invention such that the student will be reminded upon reaching a preset time, thereby facilitating the student to conduct the study.

### SUMMARY OF THE INVENTION

One aspect of the present invention is to provide an interactive learning method that is capable of reminding the person concerned the time is due to conduct the study or skill.

Another aspect of the present invention is to provide an interactive learning method such that the person concerned can conduct his study via the Internet.

Still another aspect of the present invention is to provide an interactive learning method such that the person concerned can conduct his study without the restriction of place and time.

According to embodiment the present invention, an interactive learning method for a handheld communication device is provided. The handheld communication device is communicated with a communication terminal. The learning method includes the following steps: calculating a preset time interval upon receipt of a predetermined command; generating an alarm signal after passing through the preset time interval; connecting to the communication terminal; and attending a lecture offered by the communication terminal.

According to another embodiment of the present invention, an interactive learning method for a handheld communication device is provided. The handheld communication device is communicated with a communication terminal. The learning method includes the following steps: calculating a preset time upon receipt of a predetermined command; determining ceaselessly whether the preset time is due; generating an alarm signal upon reaching the preset time; connecting to the communication terminal; and attending a lecture offered by the communication terminal.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a block diagram illustrating the structure of a handheld communication device;

FIG. 2 is a flowchart illustrating the steps of an interactive learning method according to one embodiment of the present invention for the handheld communication device;

FIG. 3 is a flowchart illustrating the substeps carried out prior to conducting one major step of the interactive learning method according to one embodiment of the present invention;

FIG. 4 is a flowchart illustrating the steps of the interactive learning method according to another embodiment of the present invention for the handheld communication device; and

FIG. 5 is a flowchart illustrating the steps of the interactive learning method according to still another embodiment of the present invention for the handheld communication device.

### DETAILED DESCRIPTIONS OF THE PREFERRED EMBODIMENTS

One aspect of the present invention is to provide an interactive learning method for a handheld communication device, which is communicated with a communication terminal. In the embodiment, the handheld communication device can be a GSM mobile phone (Global System for Mobile communication), a PHS mobile (Personal Handyphone System), an IP phone (Voice over Internet Protocol), an IP video phone or a wireless mobile phone.

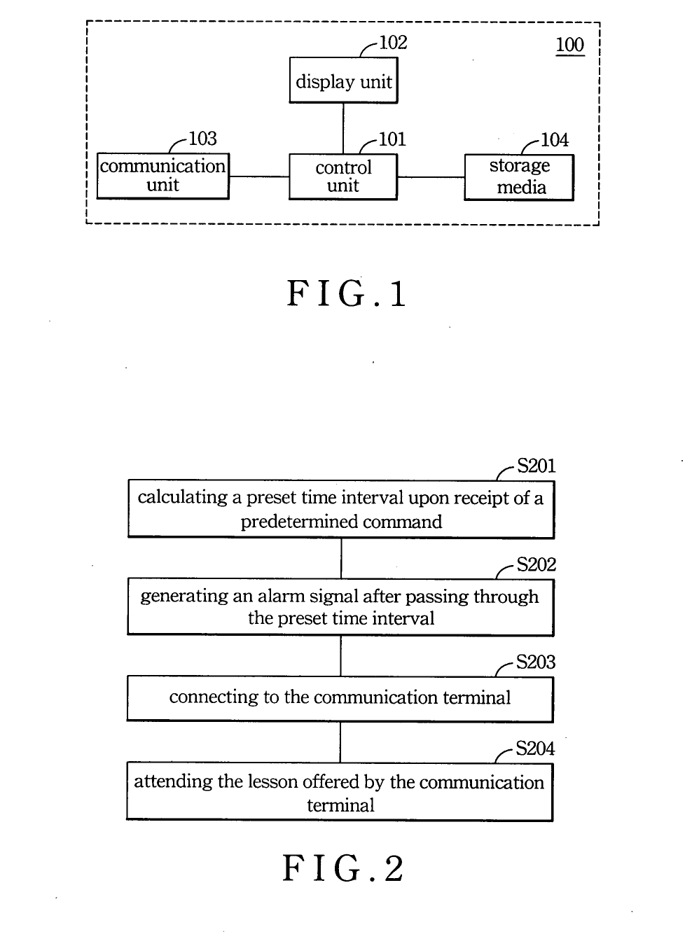

FIG. 1 is a block diagram illustrating the structure of a handheld communication device 100.

The first handheld communication device 100 generally includes a control unit 101, a display unit 102, a communication unit 103, and a storage media 104.

The control unit 101 is used for controlling the overall action of the major components of the first handheld communication device 100 such that the latter can operate. In addition, the first handheld communication device 100 further includes a power source (not shown) in order to supply electrical power to the major components for operation the latter. The power source can be a dry cell, a rectifier or an adaptor so that it can supply power to the necessary parts of the first handheld communication device 100.

Furthermore, the control unit 101 includes a timer (not shown) for constantly counting a real clock of the present world. The timer has the ability to enable the first handheld communication device 100 to generate an alarm signal at preset time. As to how the first handheld communication device 100 generates the alarm signal so as to remind the user of the device will be described in detail in the following paragraphs.

The display unit 102 is used for illustrating the interactive learning method of the present invention. The display unit 102 includes an earphone set (not shown), a microphone (not shown), an oscillator (not shown) and a display panel (not shown) or a combination of any these elements. Thus, the display unit 102 is capable of displaying letters, images, oscillation and short messages or a combination of any these parameters so that the user of the first handheld communication device 100 can study and learn the lesson or lecture with the assistance of the display unit 102.

The communication unit 103 provides the basic functions of the first handheld communication device 100 so that the latter is capable of establishing communication with a second handheld communication device (not shown), the abroad phone, the local phone and the Internet. The communication unit 103 establishes communication with the second handheld communication device, the abroad phone and the local phone and the Internet via a communication network.

The communication network can be GSM system, PHS system, or other wireless communication system. The aforesaid communication systems include a plurality of local base stations (not shown). In other words, the communication network includes several local base stations, each of which is capable of communicating with a wired phone (like residential phone) or the Internet.

In addition, the local base stations are intercommunicated with one another such that each local base station is in communication with a wired phone (the residential phone) or the Internet such the first handheld communication device 100 can established communication with the second handheld communication device, the abroad phone, the local phone or the Internet.

The storage media 104 is capable of storing data. The control unit 101, upon recording the voice mails, the images or the short messages, is capable of storing the aforesaid voice mails, the images and the short messages within the storage media 104. Under this condition, the user of the first handheld communication device 100 is capable of playing out the voice mails, the images and the short messages via the display unit 102. The storage media 104 can be a built-in memory device of the first handheld communication device 100. Alternately, the storage media 104 can be a portable storage device, a Flash card and a memory card (such as SD card).

The interactive learning method of the present invention will be described with reference to FIGS. 1 and 2, wherein FIG. 2 illustrates the steps for the handheld communication device 100. The interactive learning method includes the following steps.

In step (S201), upon receipt of a predetermined command, a preset time interval is calculated. The control unit 101 calculates out the preset time interval based on the predetermined command generated by a timer upon reaching a specific time setup by the user.

In step (S202), an alarm signal is generated after passing through the preset time interval. The control unit 101 is capable of recording and determining ceaselessly whether the preset time interval is due at the moment. For instance, the timer is required to record for a period of the time interval for an hour. Upon reaching the last minute of the set hour, the control unit 101 generates a command transmitting to the display unit 102 such that the alarm signal is displayed over the display unit 102.

The alarm signal can be a sound, such as voice speech or music. Of course, in case the user of the handheld communication device 100 is at a situation not fit for receiving the sound, the display unit 102 can be arranged to generate a vibration action. Under this condition, the user of the first handheld communication device 100 can get ready for attending the lesson or lecture provided according to one embodiment of the present invention.

In step (S203), the first handheld communication device 100 is connected to the communication terminal via the communication network. In step (S204), the user of the first handheld communication device 100 can attend the lesson or lecture provided according to one embodiment of the present invention.

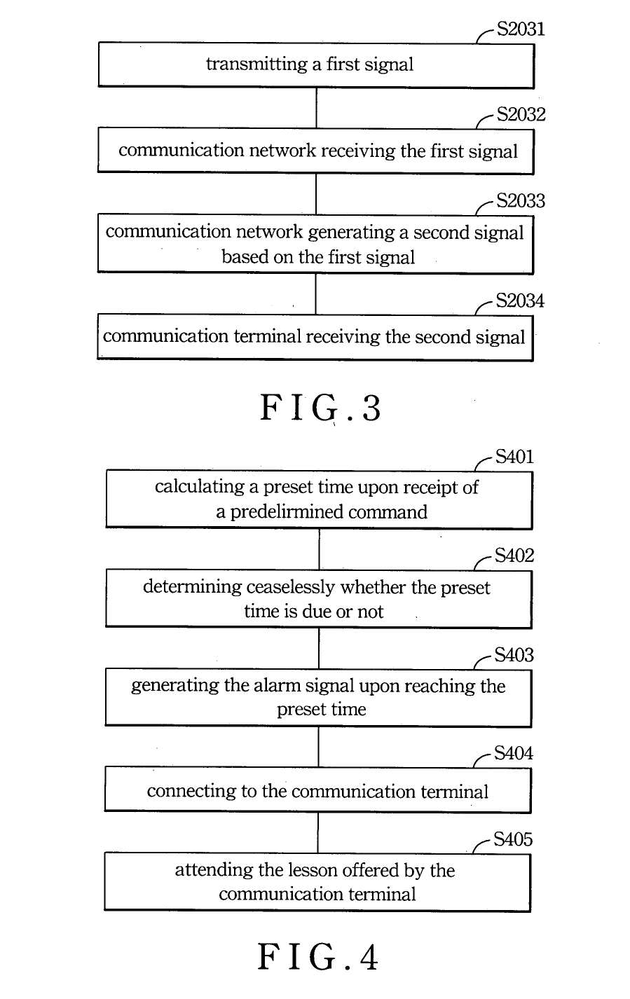

Referring to FIG. 3, prior to performance of the step (S203), the connecting to the communication terminal may further include the following substeps:

The control unit 103 generates a first signal (S2031), which is received by the communication network (S2032). Since the communication network includes several local base stations and each of the local base stations includes a transceiver for receiving the first signal. Thus, the communication network is capable of receiving the first signal.

The communication network transmits a second signal (S2033) in response to and depending on the frequency of the first signal. The second signal is transmitted to the communication terminal. Since the frequency of the first signal has a unique identification, the communication network is capable of generating and transmitting the second signal to the communication terminal without causing any undesired error.

In some cases, the communication terminal is the second handheld communication device, the receipt of the first signal and the transmission of the second signal are carried out by the local base stations. If the communication terminal is a server, a computer set, a local phone (for example, a residential phone) and an abroad phone (for example, a residential phone), the local base station usually decoded the first signal upon receipt thereof. The decoded signal is later transmitted to the Internet or a wired phone. Thus, the first handheld communication device 100 is in communication with the communication terminal.

The second signal (S2034) is received by the communication terminal. Upon receipt of the second signal, a communication is established automatically between the communication terminal and the first handheld communication device 100. Under this condition, the user of the first handheld communication device 100 can get ready to attend the lecture offered by the communication terminal.

FIG. 4 is a flowchart illustrating the steps of the interactive learning method according to another embodiment of the present invention, which include the following steps;

In step (S401), a preset time is calculated upon receipt of a predetermined command.

In step (S402), determine ceaselessly whether the preset time is due or not.

In step (S403), the alarm signal is generated upon reaching the preset time. In other words, the alarm signal is generated when the time is due.

In one embodiment, the built-in timer of the control unit 101 is capable of recording and determining ceaselessly whether the preset time is due at the moment by comparing with a real clock and whether a period of waiting interval has elapsed at the moment.

For instance, upon receipt of the predetermined command, the first handheld communication device 100 displays a preset time, such as PM 7:00. Since the build-in timer in the first handheld communication device 100 is the same as a real clock, the build-in timer is capable of ceaselessly counting the passing time and simultaneously recording the passing time, thereby conducting a comparison of the passing time with respect to the real clock. Upon reaching a current time is PM 7:00, the built-in timer is capable of determining whether the current time is the preset time. Under this condition, the PM 7:00 is displayed over the display unit 102 of the first handheld communication device 100, thereby reminding the user of the device 100 to get ready for attending the lecture offered by the communication terminal.

A lunar calendar can serve as the preset time in the second embodiment of the interactive learning method of the present invention so as to facilitate drawing up a timetable in order to assist in the learning process of the user.

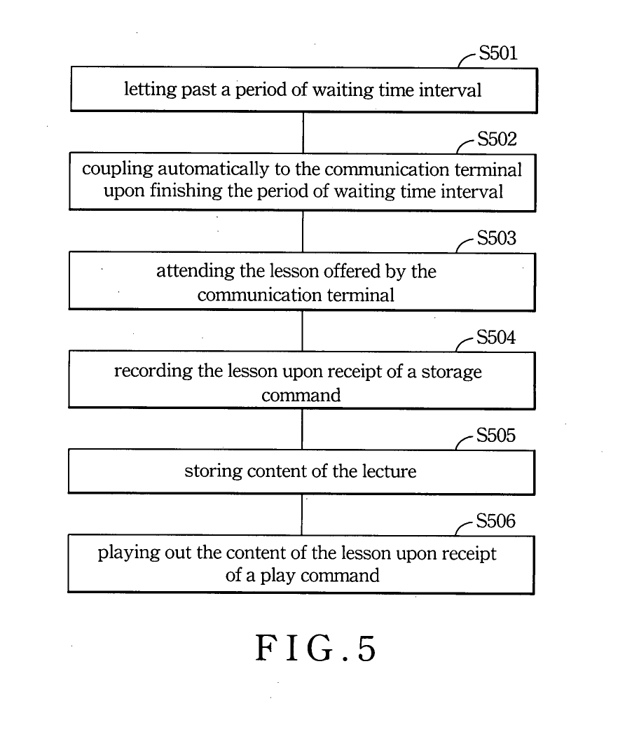

FIG. 5 is a block diagram illustrating the steps in still another embodiment of the interactive learning method according to the present invention. This embodiment is generally similar to the aforesaid embodiments. The only difference resides in that a period of waiting interval and recording contents of the lecture are included in this embodiment.

As illustrated, after the step (S202) of FIG. 2 or the step (S403) of FIG. 4 and after generating the alarm signal, the built-in time in the first handheld communication device 100 will let past a period of waiting interval, according to the step (S501). Upon finishing the period of waiting interval, the communication unit 103 of the first handheld communication device 100 is automatically coupled to the communication terminal in step (S502). In step (S503), the user can attend the lecture offered by the communication terminal.

As illustrated, the user after receipt of the alarm signal can get ready during the waiting interval, such as finishing or laying down the task he is working on. The user can also adjust the waiting interval depending on the individual desire.

The present embodiment further includes the following steps. In (S504), the control unit 101 is capable of recording the lecture upon receipt of a storage command. In step (S505), the control unit 101 is further capable of storing contents of the lecture in the storage media 104. In step (S506), the first handheld communication device 100 is capable of playing out the contents of the lecture upon receipt of a play command.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An interactive learning method for a first handheld communication device that is communicated with a communication terminal, the learning method comprising:
calculating a preset time interval upon receipt of a predetermined command;
generating an alarm signal after passing through the preset time interval;
connecting to the communication terminal; and
attending a lecture offered by the communication terminal.

2. The interactive learning method according to claim 1, wherein after the step of generating the alarm signal further comprising:
letting past a period of waiting interval; and
coupling the first handheld communication device with the communication terminal upon finishing the period of waiting interval.

3. The interactive learning method according to claim 2, wherein the first handheld communication device includes a control unit having a timer for recording and determining ceaselessly whether the preset time interval is due at the moment and whether the period of waiting interval has elapsed.

4. The interactive learning method according to claim 1, further comprising:
recording the lecture upon receipt of a storage command; and
storing contents of the lecture for study.

5. The interactive learning method according to claim 4, further comprising
playing out the contents of the lecture upon receipt of a play command.

6. The interactive learning method according to claim 1, wherein the communication terminal is a second handheld communication device.

7. The interactive learning method according to claim 1, wherein the step of connecting to the communication terminal further comprising:
transmitting a first signal;
receiving the first signal by a communication network;
transmitting a second signal generated based on the first signal by the communication network; and
connecting the first handheld communication device with the communication terminal upon receipt of the second signal.

8. An interactive learning method for a first handheld communication device that is communicated with a communication terminal, the learning method comprising:
calculating a preset time upon receipt of a predetermined command;
determining ceaselessly whether the preset time is due;
generating an alarm signal upon reaching the preset time;
connecting to the communication terminal; and
attending a lecture offered by the communication terminal.

9. The interactive learning method according to claim 8, wherein after the step of generating the alarm signal further comprising
letting past a period of waiting interval; and
coupling the first handheld communication device with the communication terminal upon finishing the period of waiting interval.

10. The interactive learning method according to claim 9, wherein the first handheld communication device includes a control unit having a timer for recording and determining ceaselessly whether the preset time is due at the moment and whether the period of waiting interval has elapsed.

11. The interactive learning method according to claim 8, further comprising
recording the lecture upon receipt of a storage command.

12. The interactive learning method according to claim 11, further comprising
playing out contents of the lecture upon receipt of a play command.

13. The interactive learning method according to claim 8, wherein the step of connecting to the communication terminal further comprising:
transmitting a first signal;
receiving the first signal by a communication network;
transmitting a second signal generated based on the first signal by the communication network; and
connecting the first handheld communication device with the communication terminal upon receipt of the second signal.

14. The interactive learning method according to claim 8, wherein the communication terminal is a second handheld communication device.
